(19) United States
(12) Patent Application Publication
(10) Pub. No.: US 2015/0076175 A1
(43) Pub. Date: Mar. 19, 2015

(54) Mountable Thermos

(71) Applicant: Barry Smith, Scotia, NY (US)

(72) Inventor: Barry Smith, Scotia, NY (US)

(21) Appl. No.: 14/491,964

(22) Filed: Sep. 19, 2014

Related U.S. Application Data
(60) Provisional application No. 61/879,935, filed on Sep. 19, 2013.

(51) Int. Cl. A47J 41/00

(52) U.S. Cl. CPC A47J 41/0083
USPC 222/181.3

(57) ABSTRACT

Described is a mountable thermos adapted to be secured to a tree or other vertical support surface. The thermos includes a container having a bottom end, sidewalls, and an open upper end having a removable lid thereon. The sidewall of the container includes a spout that allows a user to easily dispense the substance held within the container. The container further includes a handle to allow a user to grasp the thermos, and a mounting attachment that can be removably engaged with a fastener that can be inserted into a tree or other surface. The container may further include a tray assembly on the bottom end thereof, wherein the tray assembly can be extended so as to support a cup below the spout. Further, a cup can be removably secured on the upper end of the container in an upside-down configuration for storage and travel.

### CROSS REFERENCE TO RELATED APPLICATION

This application claims the benefit of U.S. Provisional Application No. 61/978,935 filed on Sep. 19, 2013, entitled “Sportsman Tree Stand Thermos.” The above identified patent application is herein incorporated by reference in its entirety to provide continuity of disclosure.

### BACKGROUND OF THE INVENTION

### Field of the Invention

The present invention relates to a mountable thermos, particularly suited for hunters positioned in tree stands. More specifically, the present invention provides a thermos that can be removably mounted in a vertical orientation on a tree or other surface. The thermos includes a spout for dispensing the contents of the thermos, and a removable lid. The thermos further includes a tray assembly from which a tray can be extended to support a cup below the spout. Additionally, a cup is provided that can be stored in an upside-down orientation on the upper end of the thermos.

Hunters often use tree stands, which are platforms secured to trees in elevated positions. The tree stand provides hunters with an improved vantage point relative to standing on the ground. The hunter is able to see a greater distance, and may be able to see animals that would otherwise be obscured by trees, shrubs, or other vegetation. Further, the elevated position helps to conceal the hunter's scent and location so that animals will draw closer to the hunter's location.

Hunters may spend extended periods of time in tree stands while waiting for an animal to appear, and often bring thermoses so that the hunters can eat and drink while in the tree stand. However, traditional thermoses can be cumbersome to handle while in a tree stand. The hunter must hold the thermos in one hand and remove the cup on the thermos. The hunter must also remove the lid on the thermos so that the hunter can pour the contents of the thermos into the cup. Removing and holding multiple components can be challenging, and requires a person to use both of his or her hands. Further, while in a tree stand the hunter has no place on which a cup or the thermos can be rested. When handling the thermos and cup, the hunter risks dropping the thermos and spilling the contents thereof, causing the hunter to lose his or her food or beverage. Dropping the thermos may also require the hunter to leave the tree .stand to retrieve the thermos. Additionally, the noise generated by dropping the thermos may scare animals, causing them to move farther away from the hunter.

The present invention provides a mountable thermos adapted to be secured to a vertical surface, such as a tree. The thermos comprises a cylindrical container having a bottom end, sidewalls, and an open upper end. The open upper end can be removably secured by a lid. A cup can be positioned in an upside-down orientation over the lid on the upper end of the container. The container further comprises a mounting attachment for securing the container to a bracket having a fastener thereon, wherein the bracket is adapted to receive the mounting attachment, and the fastener can be inserted into a tree or other support surface. The thermos further includes a handle for holding the container and a spout thereon that allows a user to dispense the substance held within the container. A tray assembly is positioned on the bottom end of the thermos and includes a tray that can be extended outward such that it is underneath the spout, allowing a user to place a cup thereon to be filled by the spout. Thus, by mounting the thermos of the present invention, the hunter can use both of his hands for other purposes, and the risk of dropping the thermos is eliminated. Further, the tray provides a resting surface for a cup so that the hunter does not have to hold the cup while filling the cup or when not drinking therefrom.

### DESCRIPTION OF THE PRIOR ART

Devices have been disclosed in the prior art that relate to beverage holding devices. These include devices that have been patented and published in patent application publications. These devices generally relate to beverage holders adapted to hold a beverage container therein, and that are mountable to various surfaces. The following is a list of devices deemed most relevant to the present disclosure, which are herein described for the purposes of highlighting and differentiating the unique aspects of the present invention, and further highlighting the drawbacks existing in the prior art.

One such device, U.S. Patent Application Publication Number 2012/0111875 to Johnson discloses an object holding device. The device includes a base on which a support arm having a basket thereon is mounted. The basket is able to rotate on the support arm. The device allows an object to be held securely regardless of the incline or slope of the surface on which the object is placed. Thus, Johnson relates only to an object holding device, and does not disclose a thermos that is mountable on a vertical surface, such as a tree.

U.S. Patent Application Publication Number 2013/0037586 to Richter et al. discloses a suspended cup holder. The device includes a support ring having a basket suspended thereon. The support ring hangs from a plurality of elastic ring suspenders, and the ring suspenders are connected to a support bracket. The support bracket is adapted to attach the cup holder to a bicycle, hand cart, or other similar device. Thus, Richter et al. discloses a cup holder that can be secured to a bicycle, and does not disclose a thermos that is mountable to a vertical support surface and that includes a spout through which the contents of the thermos can be dispensed.

U.S. Patent Application Publication Number 2002/0145096 to Eubanks discloses a collapsible drink holder that can be attached to a tree stand. The drink holder includes a ring on which a flexible pouch is disposed. A beverage can be positioned within the flexible pouch. A securing arm is attached to the ring and includes a channel on an end thereof that can be engaged with a horizontal arm section of a tree stand. Thus, Eubanks discloses a device that can be secured to a tree stand that is adapted to support a beverage in an upright orientation. However, Eubanks fails to disclose a thermos that is removably securable to a tree.

U.S. Patent Application Publication Number 2009/0206098 to Garahan discloses a portable beverage holding device. The device includes a basket suspended from a movable piece disposed on a plate. The plate includes a strap and can be secured to a hanging member for suspending the device on a stationary object or moving vehicle. Thus, Garahan discloses a beverage holding device mountable to various objects, but does not disclose a thermos in which a beverage or other substance can be held.

Finally, U.S. Patent Application Publication Number 2006/0022006 to Cruise discloses a collapsible carrying device. The carrier can be used to hold beverages and can be positioned between the handles of wheeled luggage, such as a suitcase. The device is adapted to remain in an upright position while the luggage is moved. Accordingly, Cruise fails to disclose a thermos that is mountable to a vertical support surface, and discloses only a holding device in which a beverage container or other object can be positioned.

These prior art devices have several known drawbacks. The devices in the prior art primarily relate to cup holder or beverage holding devices. Thus, the prior art devices are not adapted to store a beverage or other substance therein. Further, the prior art devices do not include a means for dispensing a beverage and do not include a tray on which a cup or container can be positioned. The present invention provides a thermos that can be removably mounted to a vertical support surface, and that is able to hold a beverage or other substance. The substance can be dispensed from the thermos through a spout thereon. A cup can be stored on the upper end of the container of the present invention, and can be placed on an extendable tray such that the cup is positioned beneath the spout.

In light of the devices disclosed in the prior art, it is submitted that the present invention substantially diverges in design elements from the prior art and consequently it is clear that there is a need in the art for an improvement to existing mountable beverage container devices. In this regard the instant invention substantially fulfills these needs.

### SUMMARY OF THE INVENTION

In view of the foregoing disadvantages inherent in the known types of mountable containers now present in the prior art, the present invention provides a new mountable container wherein the same can be utilized for providing convenience for the user when carrying and holding a container having food or beverage therein, and using the same to fill a cup or other container.

It is therefore an object of the present invention to provide a new and improved mountable thermos device that has all of the advantages of the prior art and none of the disadvantages.

It is another object of the present invention to provide a mountable thermos that can be removably secured to a vertical support surface in an upright orientation.

Another object of the present invention is to provide a mountable thermos that includes a spout for dispensing a substance held therein.

Yet another object of the present invention is to provide a mountable thermos that includes an extendable tray that can be extended from the bottom end of the thermos and that is able to support a cup thereon.

A further object of the present invention is to provide a mountable thermos that comprises a cup stored thereon in an upside-down configuration on an upper end of the thermos.

Another object of the present invention is to provide a mountable thermos that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the mountable thermos of the present invention.

FIG. 2A shows a cross sectional view of an embodiment of the mountable thermos as secured to a support surface.

FIG. 2B shows a top down view of an embodiment of the mountable thermos of the present invention.

FIG. 2C shows a perspective view of an embodiment of the mountable thermos as positioned for mounting to a tree.

FIG. 3 shows a perspective view of a cup as stored on the mountable thermos of the present invention.

FIG. 4 shows a perspective view of the mountable thermos having an extendable tray assembly.

### DETAILED DESCRIPTION OF THE INVENTION

Reference is made herein to the attached drawings. Like reference numerals are used throughout the drawings to depict like or similar elements of the mountable thermos of the present invention. For the purposes of presenting a brief and clear description of the present invention, the preferred embodiment will be discussed as used for providing a user with a means for securing a thermos to a support surface. The figures are intended for representative purposes only and should not be considered to be limiting in any respect.

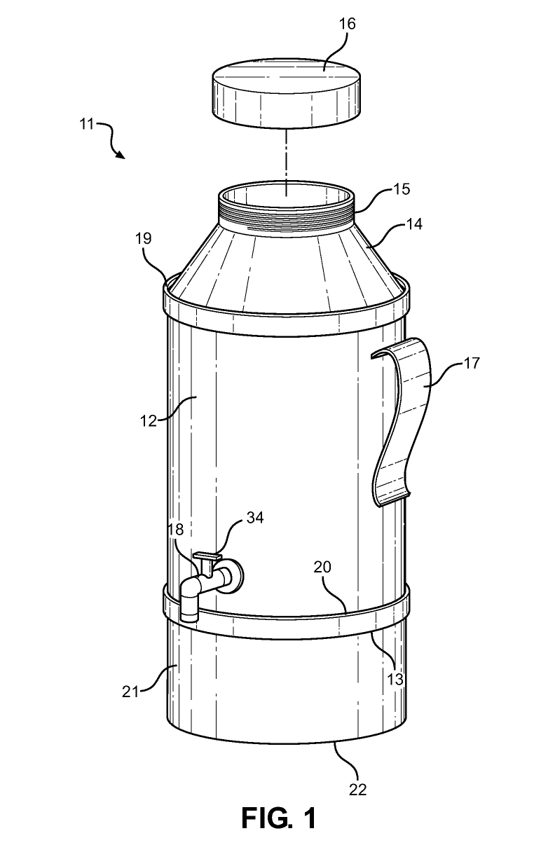

Referring now to FIG. 1, there is shown a perspective view of an embodiment of the mountable thermos of the present invention. The mountable thermos 11 comprises a container having an interior volume defined by a bottom end 13, a sidewall 12, and an upper end 14 having an opening 15 thereon. Preferably, the container comprises a cylindrical shape. In the illustrated embodiment, the upper end 14 is tapered such that the cross section of the opening 15 thereon is smaller than the cross section of the bottom 13 of the container. The opening 15 on the upper end 14 provides a user with access to the interior of the container so that the user may fill the container or empty the contents thereof.

In some embodiments of the present invention, the sidewalls 12 and upper end 14 of the container includes an exterior layer thereon. The exterior layer surrounds the sidewall 12 and upper end 14 of the container and preferably comprises rubber, or another similar substance. The exterior layer serves to insulate the container, and also helps to reduce noise produced by the container when the container strikes another object. Conventional metal thermoses may produce a loud noise if the metal thermos contacts another object or if the thermos is dropped. Further, the metal surface of a thermos may reflect light, drawing the attention of animals towards the hunter. In contrast, the rubber or similar material exterior layer does not reflect light, and is discrete. The exterior layer may comprise a camouflage pattern thereon to further disguise the mountable thermos 11.

The mountable thermos 11 further comprises a lid 16 that, can be removably secured to the opening 15 on the upper end 14 of the thermos 11. Preferably, the exterior of the opening 15 on the upper end 14 of the thermos 11 comprises threading adapted to engage with threading on the interior surface of the lid 16. In this way, the lid 16 can be removably secured to the upper end 14 of the container so as to enclose the interior volume of the thermos 11.

The sidewall 12 of the container comprises a handle 17 thereon. The handle 17 is preferably arranged in a vertical orientation and extends from an upper portion of the container towards a lower portion thereof. Further, the sidewall 12 of the container includes a spout 18 thereon. The spout 18 comprises a tubular member that extends outward from the sidewall 12 of the container and is turned downward at an end thereof. The spout 18 allows a substance held within the interior volume of the container to be dispensed. Preferably, the spout 18 is located on a lower portion of the container. Further, the spout 18 includes a valve 34 thereon that can be opened as desired by the user in order to dispense the substance held within the container.

A tray assembly 21 is attached to the bottom end 13 of the container of the present invention. The tray assembly 21 includes a cylindrical housing disposed on the bottom end 13 of the container. The cylindrical housing has a hollow interior volume and is used to store a tray therein. The cylindrical housing includes a bottom end and a sidewall extending partially therearound. Preferably, the tray is circular and can be slidably extended from the housing so that a cup can be positioned thereon.

The container further includes an annular flange 20 around the circumference of the bottom end 13 of the container. Similarly, the upper end 14 includes an annular flange 19 around the circumference thereof. The flanges 19, 20 are preferably composed of rubber, or another similar material. The flanges 19, 20 help to prevent the thermos from making noise when placed on a surface, or when the thermos contacts another object. Further, the flange 19 on the upper end 14 of the container helps to secure a cup positioned on the container in an upside-down orientation.

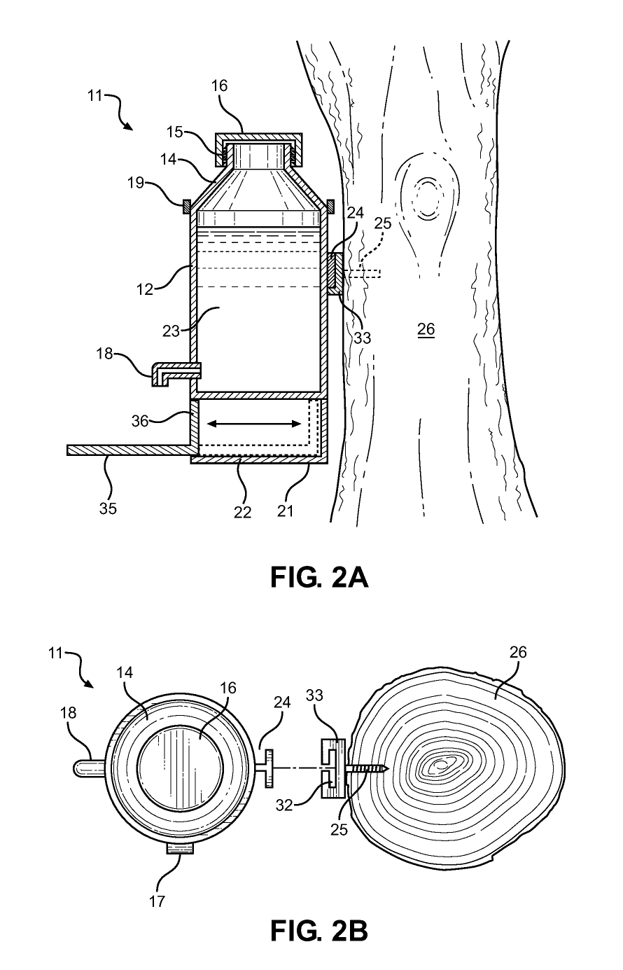

Referring now to FIG. 2A through 2C, there are shown views of the mountable thermos of the present invention as positioned for mounting and as mounted to a support surface. The thermos 11 is adapted to be secured to a vertical support surface 26, such as a tree or a wall, such that the thermos 11 is positioned in a vertical, upright orientation. The container includes a mounting attachment 24 on a sidewall 12 thereof. The mounting attachment 24 is adapted to engage with a mounting bracket 33 having a fastener 25 thereon.

The mounting attachment 24 is positioned on the sidewall 12 of the container. Preferably, the mounting attachment 24 is positioned vertically and extends from a lower portion of the container to an upper portion thereof. In the illustrated embodiment, the mounting attachment 24 includes a T-shaped cross section. The mounting bracket 33 includes a channel 38 on a front surface 39 thereof. Preferably, the channel 38 is shaped so as to receive the mounting attachment 24 on the thermos 11. Thus, in the illustrated embodiment, the channel 28 comprises a T-shaped cross section. The channel 38 includes an open upper end for insertion of the mounting attachment 24 and a closed lower end so that the mounting attachment 24 cannot fall therethrough. In this way, the mounting attachment 24 can be inserted into the channel 28 on the mounting bracket 33 so as to secure the thermos 11 thereto.

The mounting bracket 33 includes a fastener extending from the rear face thereof. The fastener is substantially perpendicular to the mounting bracket 33. The fastener 25 may resemble a nail or spike. Preferably, the fastener includes threading thereon so that it can be screwed into a tree or other support surface.

In operation, a user can mount the mounting bracket 33 on a tree 26 by inserting the fastener 25 into a tree or other support surface. The user can then manually twist or screw-in the fastener 25 so that the mounting bracket 33 is secured to the tree 26. The mounting bracket 33 is adjusted so that the channel 38 thereon is positioned substantially vertically. With the mounting bracket 33 secured to a tree, the user can align the mounting attachment 24 on the thermos 11 with the channel 38 and insert the mounting attachment 24. In this way, the thermos 11 is removably secured to the support surface, eliminating the need for the user to hold the thermos.

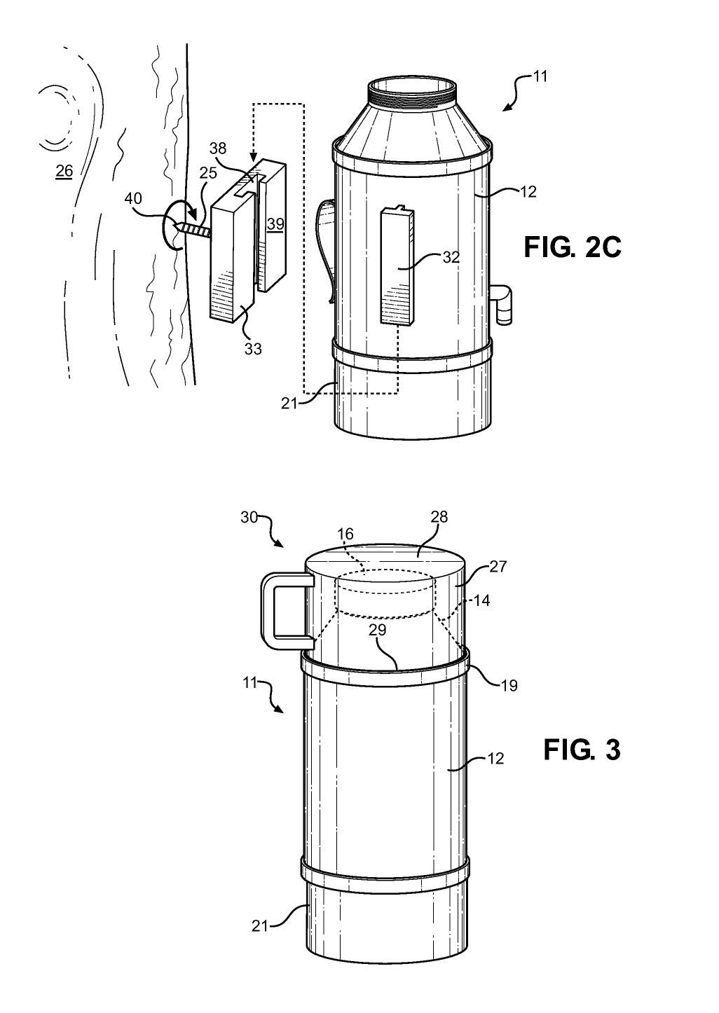

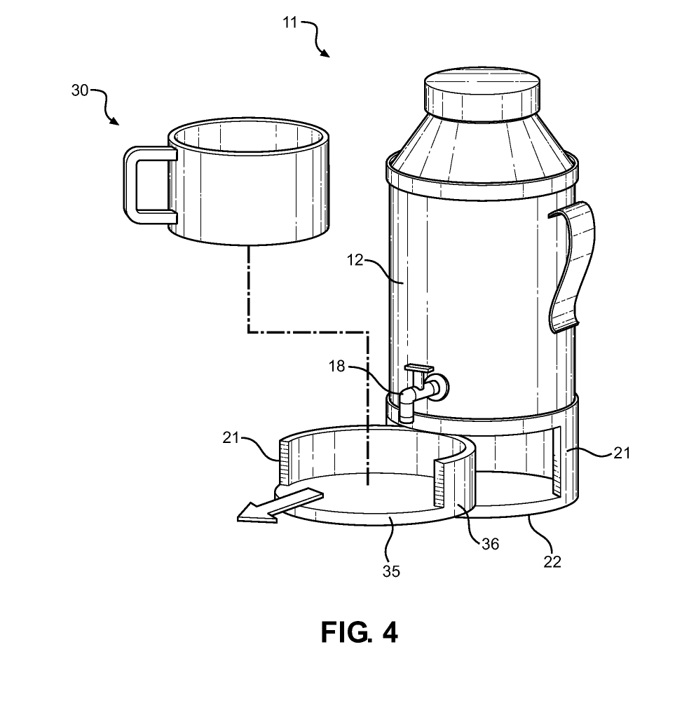

Referring now to FIG. 3, there is shown a perspective view of an embodiment of the mountable thermos of the present invention having a cup positioned thereon. The thermos 11 of the present invention further comprises a cup 30 having a bottom end 28, a sidewall 27, and an open upper end 29, defining an interior volume in which a beverage or other substance can be positioned. The cup 30 is preferably cylindrical and includes a cross section that is substantially equal to the cross section of the thermos 11. The cup 30 may further include a handle thereon to facilitate holding the cup 30.

The cup 30 is dimensioned so as to fit on top of the thermos 11 in an upside-down orientation. Thus, the cup 30 can be removably secured to the thermos 11 by placing the cup 30 in an upside-down orientation on the upper end 14 of the container. In this way, the upper end 29 of the cup contacts the upper end 14 of the container. The annular flange 19 on the upper end 14 of the container helps to position and secure the cup 30 on the thermos 11. Thus, the upper end 14 and lid 16 of the container are positioned within the interior volume of the cup 30. This allows the container, the lid 16 of the container, and the cup 30 to be assembled into a single apparatus for the convenience of the user. This prevents the need for the user to separately carry various items, such as a thermos and a cup.

In some embodiments of the present invention, the mountable thermos 11 further includes a tray assembly 21 on the bottom end thereof. The tray assembly houses an extendable tray that can be extended therefrom. The tray extends from the tray assembly so that a cup can be rested thereon. Further, the tray extends so that it is positioned underneath the spout on the thermos. In this way, a user can place a cup on the tray and can fill the cup with the spout.

In the illustrated embodiment, the tray assembly 21 includes a cylindrical housing disposed on the bottom end of the thermos, and aligned therewith. Thus the cylindrical housing is substantially the same cross section as the container of the present invention. The cylindrical housing includes a bottom end 22 and a sidewall that extends partially therearound. Preferably, the sidewall comprises a C-shape, such that the sidewall extends roughly half-way around the bottom end. An extendable tray 35 is slidably positioned within the cylindrical housing and slides along the bottom end 22 thereof. The tray 35 is substantially flat and has a circular shape. The tray 35 can be extended from the cylindrical housing by sliding the .tray therefrom. The tray 35 may further include a sidewall 36 thereon so that a cup disposed on the tray 35 is prevented from falling off of the tray 35.

In an alternate embodiment, the tray assembly includes an elongated arm having a firth end and a second end, wherein the first end is hingedly connected to the bottom end of the container. The second end is hingedly connected to a circular tray. In a collapsed configuration, the elongated arm and circular tray rest against the bottom end of the container. In an extended configuration, the elongated arm is substantially vertical and the tray is disposed horizontally so that a cup can be rested thereon. Further, the tray is spaced from the bottom end of the container and from the spout on the container so that a cup can be positioned on the tray and beneath the spout on the container. The tray may further include a sidewall extending partially around the perimeter thereof to help maintain a cup on the surface of the tray.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mountable thermos, comprising:
a container having an interior volume defined by a bottom end, a sidewall, and an upper end having an opening thereon;
a lid adapted to be removably secured to said opening on said upper end;
a spout disposed on said sidewall of said container adapted to dispense a substance held within said interior volume of said container;
a mounting attachment disposed on said sidewall;
a mounting bracket having a channel adapted to removably receive said mounting attachment, and further having a fastener adapted to be inserted into a support surface.

2) The mountable thermos of claim 1, wherein said upper end of said thermos is tapered such that said opening of said container comprises a smaller cross section than said bottom end of said container.

3) The mountable thermos of claim 1, wherein said lid comprises threading on an interior surface thereof adapted to engage with threading on an exterior surface of said opening on said upper end of said container.

4) The mountable thermos of claim 1, further comprising a handle disposed on said sidewall of said container.

5) The mountable thermos of claim 1, wherein said exterior surface of said container comprises a layer of rubber thereon.

6) The mountable thermos of claim 1, wherein said mounting attachment comprises a T-shaped cross section, and wherein said channel comprises a T-shaped cross section adapted to receive said mounting attachment therein.

7) The mountable thermos of claim 1, wherein said fastener on said mounting bracket comprises threading thereon such that said fastener can be screwed into said support surface.

8) The mountable thermos of claim 1, further comprising
a cup having a bottom end, sidewalls, and an open upper end, wherein said cup is adapted to be removably secured to said upper end of said container in an upside-down orientation such that said open upper end of said cup is positioned on said upper end of said container.

9) The mountable thermos of claim 1, wherein said spout comprises a valve thereon adapted to control the flow of said substance held within said interior volume of said container through said spout.

10) The mountable thermos of claim 1, wherein a first annular flange is disposed around a lower end of said container, and a second annular flange is disposed around an upper end of said container

11) The mountable thermos of claim 1, further comprising
a tray assembly secured to said bottom end of said container, wherein said tray assembly includes an extendable tray.

12) The mountable thermos of claim 11, wherein said extendable tray is positioned underneath said spout when in an extended configuration.

13) The mountable thermos of claim 11, wherein
said tray assembly includes a cylindrical housing having a circular bottom end, a sidewall extending partially around said circular bottom end and connecting said cylindrical housing to said bottom end of said container;
said extendable tray positioned within said cylindrical housing and slidably secured to said circular bottom end.
